(19) United States
(12) Patent Application Publication
(10) Pub. No.: US 2007/0002184 A1
(43) Pub. Date: Jan. 4, 2007

(54) Video display device and video display method

(75) Inventor: Takashi Yajima, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/476,782

(22) Filed: Jun. 29, 2006

(30) Foreign Application Priority Data
Jun. 30, 2005 (JP) 2005-193147

(51) Int. Cl. H04N 5/44

(52) U.S. Cl. 348/725; 348/734

(57) ABSTRACT

According to one embodiment, a key code of a key selected from a plurality of universal keys and information representing a function selected from a plurality of functions held by a main device are stored in a storage section in association with each other. When a key code transmitted from a remote controller is of a key corresponding to a specific function, a function corresponding to the key code is executed on the basis of a stored content of the storage section.

### CROSS-REFERENCE TO RELATED APPLICATIONS

This application is based upon and claims the benefit of priority from Japanese Patent Application No. 2005-193147, filed Jun. 30, 2005, the entire contents of which are incorporated herein by reference.

### BACKGROUND

1. Field

One embodiment of the invention relates to a video display device and a video display method such as a television broadcast receiver which are controlled by a key operation on a remote controller.

2. Description of the Related Art

As is well known, in recent years, a television broadcast receiver has an abundant variety of functions, and the number of keys arranged on a remote controller increases because of the large number of functions. For this reason, the remote controller is difficult to be handled.

In order to cope with the problem, a configuration which selects a necessary function by using a hierarchical menu, a configuration in which a lid is provided on a remote controller, the key having keys also arranged, and the like are conceived.

However, such a countermeasure does not fundamentally solve the problem. For example, in the former, an operation to move to a lower level of the hierarchical menu is cumbersome. In the later, a reduction in number of keys is limited, and the lid must be cumbersomely opened or closed.

On the other hand, at the present, there is a remote controller which can directly store codes (to be referred to remote-control codes hereinafter) allocated to the keys of the remote controller, i.e., a learning remote controller.

The learning remote controller takes in a remote-control code actually generated by a remote controller and stores the remote-control code in a memory in association with its own key. When a predetermined key is operated, a remote-control code stored in association with the key is transmitted.

A user causes the learning remote controller to store only remote-control codes desired to be used in the remote controller to simplify a cumbersome key operation, so that a key operation corresponding to a necessary function can be quickly performed.

However, the leaning remote controller has the following problems. That is, first, since remote-control codes generated by remote controllers of different manufacturers have different characteristics, taken remote-control codes may not be correctly stored.

When a battery power is exhausted, remote-control codes stored in the memory may be deleted. At the present, a remote controller with backup and a leaning remote controller which uses a nonvolatile memory appear.

Furthermore, it is impossible to select a function in a hierarchical menu. A learning remote controller which can perform programming such that a plurality of remote-control codes are sequentially transmitted is present. However, since the learning remote controller must be fixed to a predetermined position during transmission of a remote-control code, the learning remote controller is not suitable for practical use.

A preset-type remote controller which stores remote-control codes of various manufacturers appears. However, since the remote controller stores only remote-control codes corresponding to basic functions, it is not said that the remote controller is not sufficiently suitable for practical use in the real world.

Jpn. Pat. Appln. KOKAI Publication No. 9-215070 discloses the following configuration. That is, a storage section which stores control codes corresponding to buttons of a remote-control unit is arranged on a device side, a control code of the storage section is set by operating a button of the remote-control unit or a button of the device, and the device reads the control code from the storage section to control the device when the button is operated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an embodiment of the invention to explain an appearance of a television broadcast receiver;

FIG. 2 is a block diagram shown to explain a signal processing system of the television broadcast receiver according to the embodiment;

FIG. 3 is a view shown to explain a remote controller of the television broadcast receiver according to the embodiment;

FIG. 4 is a flow chart shown to explain a processing operation which associates functions with universal keys of the remote controller according to the embodiment;

FIGS. 5A and 5B are views shown to explain examples of menu screens displayed by the processing operation which associates the functions with the universal keys of the remote controller according to the embodiments;

FIG. 6 is a diagram shown to explain a function setting table which manages association between the functions and the universal keys of the remote controller according to the embodiment;

FIG. 7 is a flow chart shown to explain a processing operation of the television broadcast receiver according to the embodiment; and

FIG. 8 is a view shown to explain an example of a screen displayed by a guide function of the television broadcast receiver according to the embodiment.

### DETAILED DESCRIPTION

Various embodiments according to the invention will be described hereinafter with reference to the accompanying drawings. In general, according to one embodiment of the invention, a key code of a key selected from a plurality of universal keys and information representing a function selected from a plurality of functions held by a main device are stored in a storage section in association with each other. When a key code transmitted from a remote controller is of a key corresponding to a specific function, a function corresponding to the key code is executed on the basis of a stored content of the storage section.

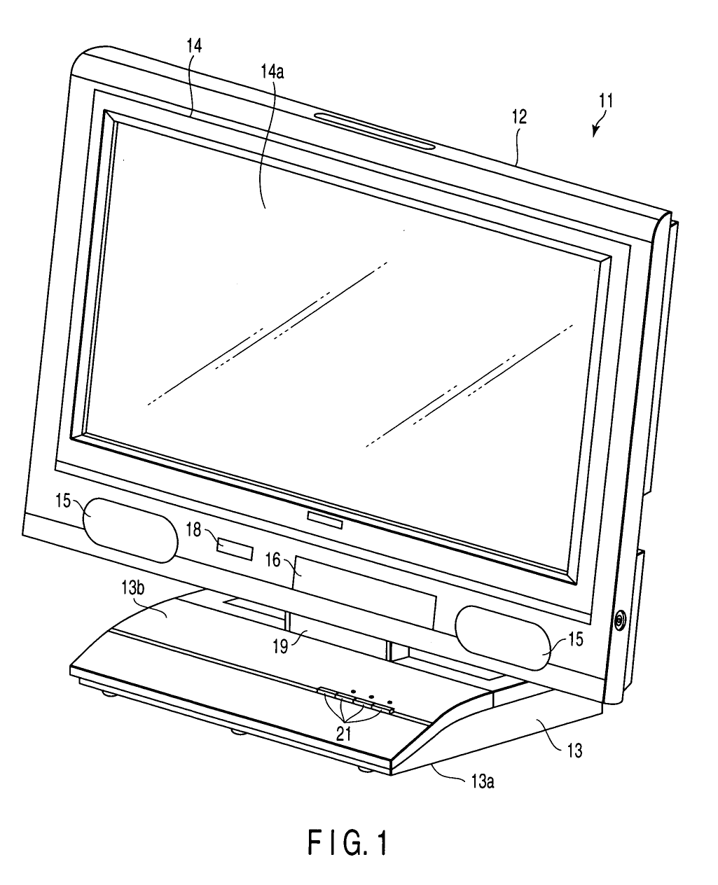

FIG. 1 shows an appearance of a front side of a television broadcast receiver 11 to be explained in the embodiment. More specifically, the television broadcast receiver 11 is constituted by a thin cabinet 12 serving as a device main body and having an almost square shape and a stand 13 which stands and supports the thin cabinet 12.

In the thin cabinet 12, a display screen 14a of the video display unit 14 constituted by, for example, a flat liquid crystal display panel is exposed to the front face of the thin cabinet 12, and a pair of loudspeakers 15, an operation section 16, a light-receiving section 18 to receive operation information transmitted from a remote controller (not shown in FIG. 1) 17, and the like are arranged.

The stand 13 is formed in the form of an almost thin box and designed such that a bottom plate 13a serving as one side of the stand 13 is placed on a predetermined base (not shown) horizontally arranged. The stand 13 is supported in such a state that a support member 19 projecting from an almost central portion of an upper plate 13b serving as a side opposing the side which is placed on the base is connected to a back surface of the cabinet 12 to stand the cabinet 12 up.

In this case, in the stand 13, an HDD section (not shown in FIG. 1) 20 to be described later is included. On the upper plate 13b of the stand 13, a plurality (four in FIG. 1) of operators 21 which can be operated by pressing to control an HDD section 20 in a recording state, a reproducing state, a stopping state, or the like are arranged on a portion hanging out of the cabinet 12.

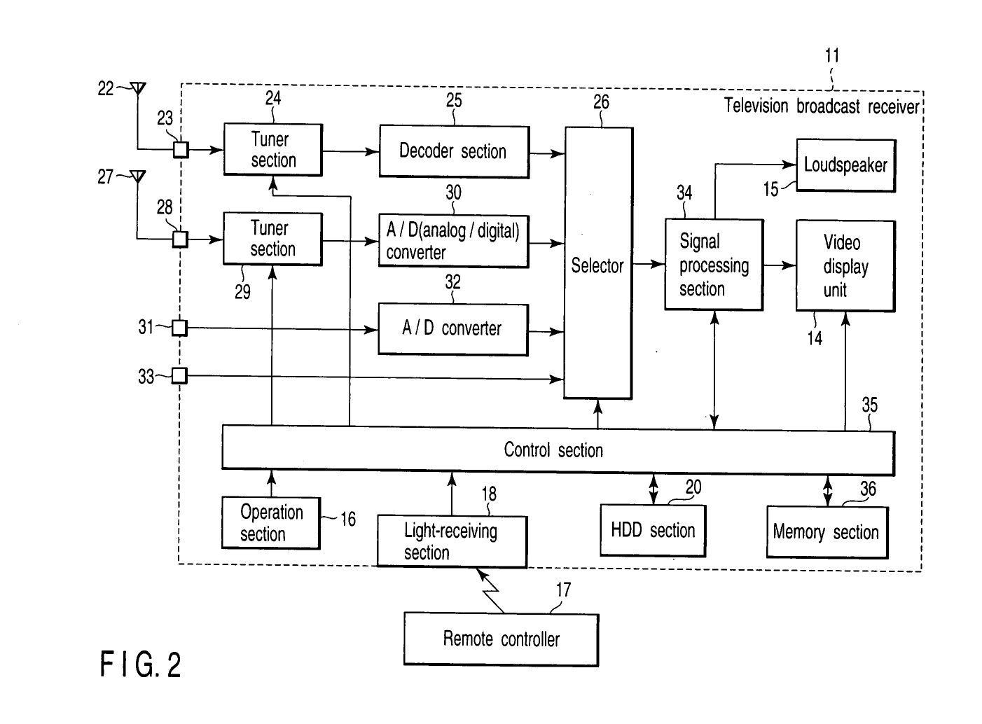

FIG. 2 schematically shows a signal processing system of the television broadcast receiver 11. Various circuit blocks constituting the signal processing system are arranged at a position close to a back surface in the cabinet 12, i.e., around a rear side of the display screen 14a of the video display unit 14.

A digital television broadcast signal received by an antenna 22 for receiving a digital television broadcast signal is supplied to a tuner section 24 through an input terminal 23. The tuner section 24 selects a signal of a desired channel from input digital television broadcasting signals to demodulate the signal. A signal output from the tuner section 24 is supplied to the decoder section 25 and subjected to, for example, an orthogonal frequency division multiplexing (OFDM) decode process, and then supplied to a selector 26.

Furthermore, an analog television broadcast signal received by an antenna 27 for receiving an analog television broadcast signal is supplied to a tuner section 29 through an input terminal 28. The tuner section 29 selects a signal of a desired channel from input analog television broadcast signals to demodulate the signal. A signal output from the tuner section 29 is digitized by an analog/digital (A/D) converter 30 and then output to the selector 26.

Analog video and audio signals supplied to an input terminal 31 for an analog signal is supplied to an A/D converter 32 and digitized, and then output to the selector 26. Furthermore, digital video and audio signals supplied to an input terminal 33 for a digital signal are directly supplied to the selector 26.

The selector 26 selects one of the input video and audio signals of four types to supply the selected signal to a signal processing section 34. The signal processing section 34 performs predetermined signal processing to the input digital video signal to cause the signal to serve to perform video display on the video display unit 14. The signal processing section 34 also generates an on-screen display (OSD) signal to display various menu screen on the video display unit 14.

As the video display unit 14, for example, a flat display panel constituted by a liquid crystal display or a plasma display. The signal processing section 34 performs predetermined signal processing to the input digital audio signal to convert the signal into an analog signal and outputs the signal to the loudspeakers 15 to perform audio reproduction.

In this case, in the television broadcast receiver 11, various operations including the various receiving operations are integrally controlled by a control section 35. The control section 35 is a microprocessor in which a central processing unit (CPU) and the like are built. The control section 35 receives operation information from the operation section 16 and the operators 21 (not shown in FIG. 2) or operation information transmitted from the remote controller 17 through the light-receiving section 18 to control the respective sections such that the operation contents are reflected.

In this case, the control section 35 uses a memory section 36. The memory section 36 mainly includes a read only memory (ROM) which stores a control program executed by the CPU, a random access memory (RAM) to provide a work area to the CPU, and a nonvolatile memory in which various setting information, control information, and the like are stored.

In this case, the control section 35 is connected to the HDD section 20 stored in the stand 13. In this manner, the television broadcast receiver 11 can record digital video and audio signals selected by the selector 26 by using the HDD section 20. The control section 35 can also reproduce the digital video and audio signals recorded on the HDD section 20 to cause the signals to be used in an audio-visual service.

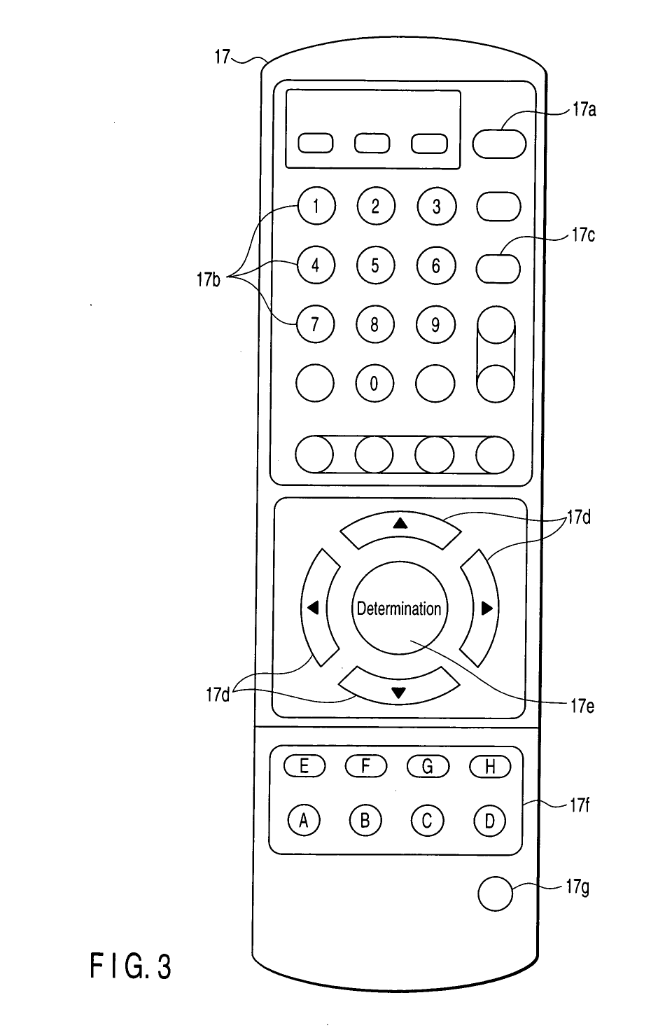

FIG. 3 shows an appearance of the remote controller 17. On the remote controller 17, mainly, a power source key 17a, a number key 17b, a menu key 17c, a cursor key 17d, a decision key 17e, a key group 17f having eight universal keys A to H, a display key 17g, and the like are arranged.

Various functions held by the television broadcast receiver 11 can be selectively associated with the universal keys A to H, respectively. In this manner, the universal keys A to H are operated to make it possible to execute the functions associated with the operated universal keys A to H.

In this case, of the various functions held by the television broadcast receiver 11, functions in a hierarchical menu can also be associated with the universal keys A to H, respectively. More specifically, the universal keys A to H are operated to make it possible to execute the functions in the hierarchical menu.

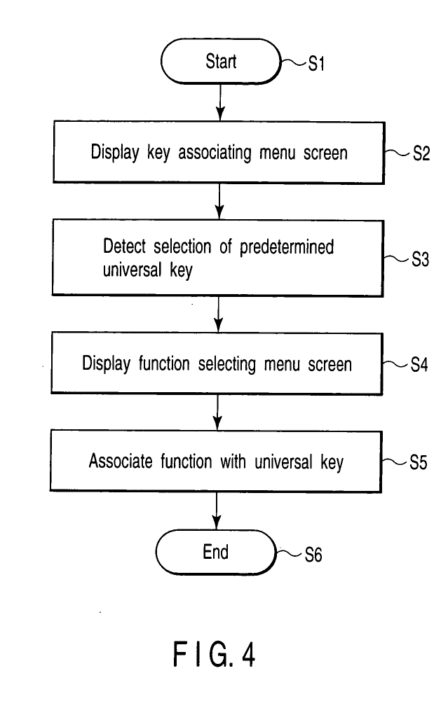

FIG. 4 is a flow chart for explaining a processing operation which selectively associates the various functions held by the television broadcast receiver 11 to the universal keys A to H of the remote controller 17. The processing operation is started such that a user operates the remote controller 17 to display a key associating menu screen on the video display unit 14 (block S1).

The key associating menu screen can be displayed by the following method. That is, the menu key 17c of the remote controller 17 is operated to display a menu screen located at the uppermost level of the hierarchy, and the cursor key 17d and the decision key 17e are operated on the menu screen to move the operation to a lower level of the hierarchy.

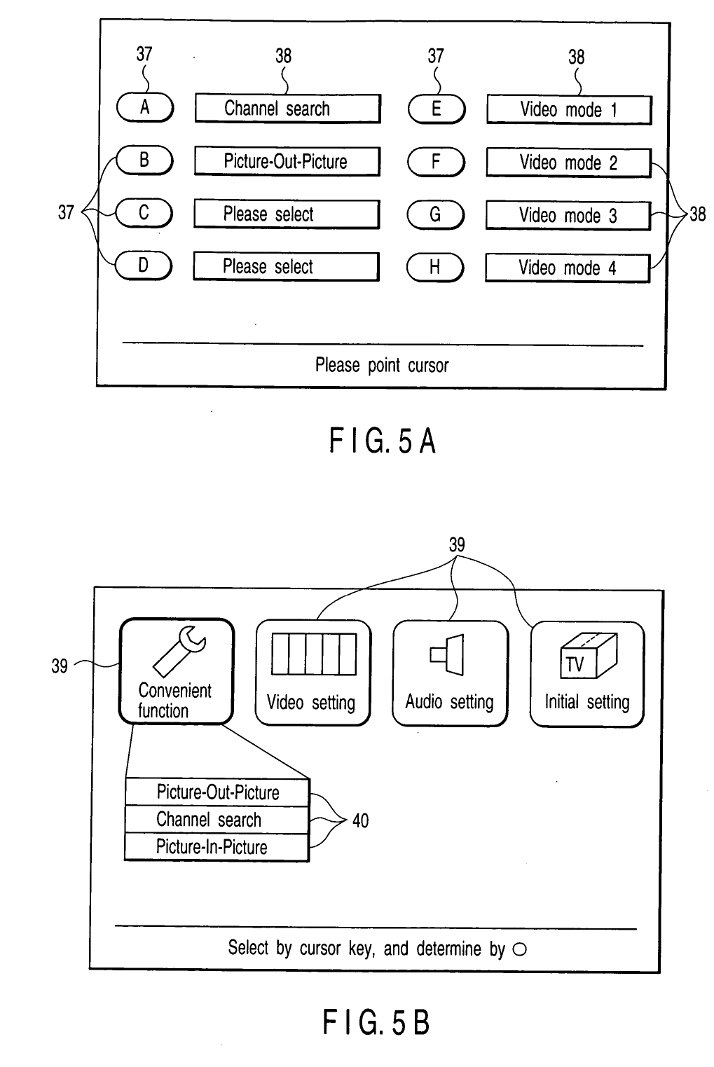

In this manner, the operation to display the key associating menu screen is performed, the control section 35 displays the key associating menu screen on the video display unit 14 in block S2. The key associating menu screen, as shown in FIG. 5A, an item 37 representing each of the universal keys A to H and an area 38 in which a function is displayed in association with the item 37 are displayed.

On the key associating menu screen, a user operates the cursor key 17d of the remote controller 17 to make it possible to select the item 37 representing a desired one of the universal keys A to H.

In this case, when the control section 35 detects that a predetermined one of the universal keys A to H is selected on the key associating menu screen in block S3, the control section 35 causes the video display unit 14 to display a function selecting menu screen in block S4.

On the function selecting menu screen, as shown in FIG. 5B, the various functions held by the television broadcast receiver 11 are classified into four items 39, i.e., “convenient function”, “video setting”, “audio setting”, and “initial setting” and displayed.

On the function selecting menu screen, a user operates the cursor key 17d of the remote controller 17 to select a desired one of the items 39 (“convenient function” in FIG. 5B). At this time, an item 40 representing various functions (picture-out-picture, channel search, picture-in-picture, and the like) included in the selected item 39 is displayed.

For this reason, the user operates the cursor key 17d of the remote controller 17 to make it possible to select the item 40 corresponding to a desired function, and operates the decision key 17e to make it possible to select a desired function to be associated with the selected one of the universal keys A to H.

When the control section 35 detects that a predetermined function is selected on the function selecting menu screen, the control section 35 associates the function selected by the user to the selected one of the universal keys A to H to in block S5 and ends the process (block S6).

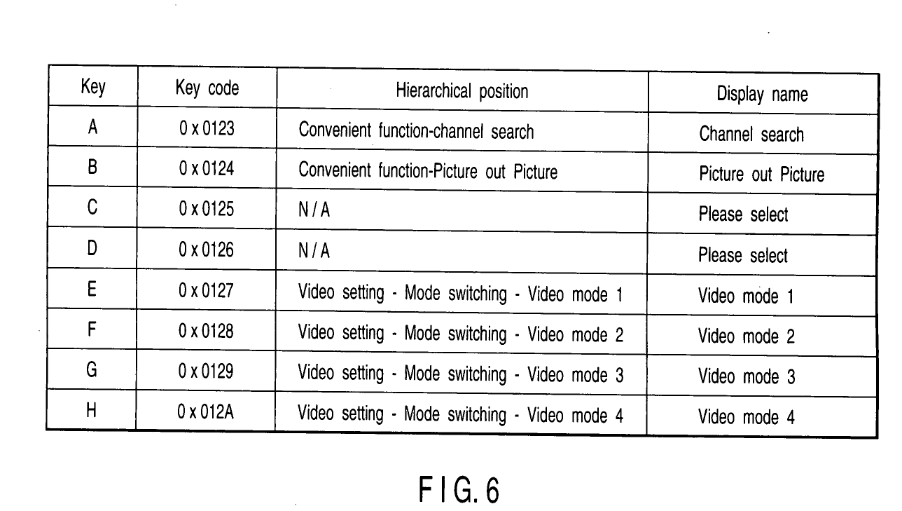

In this case, the association between the universal keys A to H and the functions is managed by a function setting table. The function setting table, as shown in FIG. 6, stores key codes assigned to the universal keys A to H and pieces of information (hierarchical positions and names) for specifying functions in association with each other. The function setting table is stored in a nonvolatile memory in the memory section 36.

The function setting table shown in FIG. 6 shows the following state. That is, a channel search function, a picture-out-picture function, a video mode 1 function, a video mode 2 function, a video mode 3 function, and a video mode 4 function are associated with the universal key A, the universal key B, the universal key E, the universal key F, the universal key G, and the universal key H, respectively, and no functions are associated with the universal keys C and D.

According to the association between the universal keys A to H and the functions, functions in a hierarchical menu can be directly associated with the universal keys A to H, respectively.

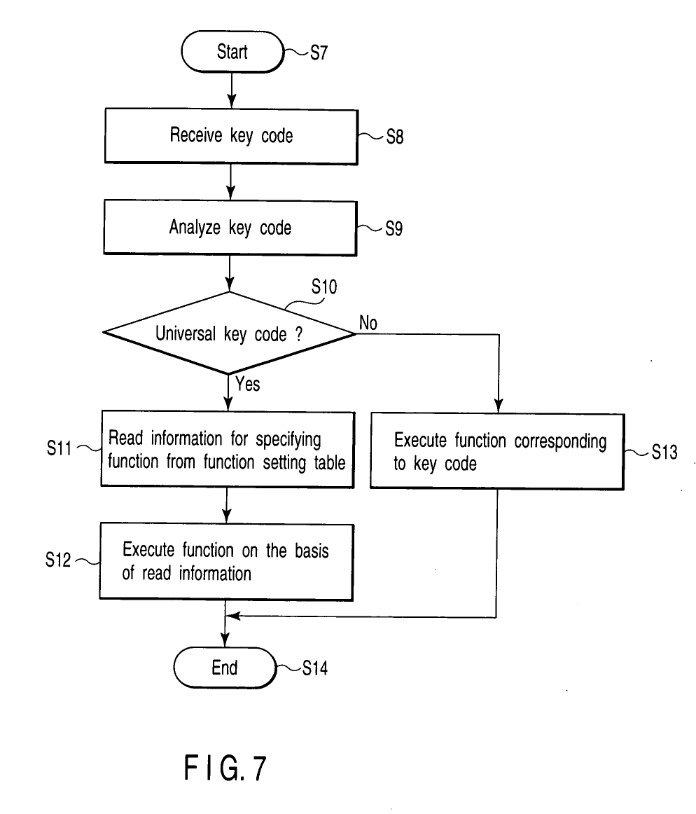

FIG. 7 shows a flow chart for explaining a processing operation of the television broadcast receiver 11 when a key operation for the remote controller 17 is performed. More specifically, when the process is started (block S7) to receive a key code transmitted from the remote controller 17 in block S8, the control section 35 analyzes the received key code in block S9 and determines whether the key code is one of the key codes of the universal keys A to H in block S10.

When it is determined that the key codes is one of the key codes of the universal keys A to H (YES), the control section 35 reads information for specifying a function corresponding to the key code with reference to the function setting table in block S11, executes the function on the basis of the read information in block S12, and ends the process (block S14).

When it is determined that the key code is not one of the key codes of the universal keys A to H in block S10 (NO), the control section 35 executes a function corresponding to the key code in block S13 and ends the process (block S14).

According to the embodiment, the various functions held by the television broadcast receiver 11 are designed to be selectively associated with the universal keys A to H arranged on the remote controller 17, so that the associated functions can be executed by operating the universal keys A to H.

For this reason, since a user can associate a function which he/she frequently uses with one of the universal keys A to H, the user can easily handle the remote controller and obtain operability which is sufficiently suitable for practical use. Furthermore, since keys classified into functions need not be arranged on the remote controller 17, the number of keys can be reduced.

In addition, the functions in the hierarchical menu can be directly associated with the universal keys A to H. For this reason, only the universal keys A to H are operated to make it possible to execute necessary functions without performing a cumbersome operation which moves the operation to a lower level of the hierarchy. Therefore, with respect to this point, handling for a user can be made convenient.

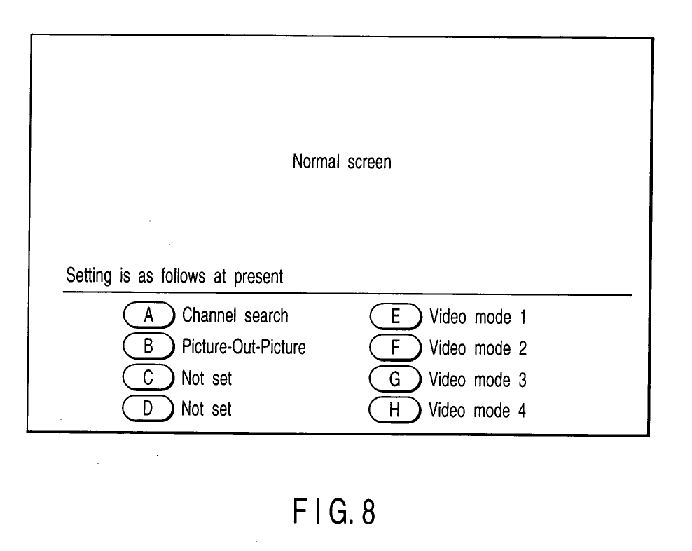

A guide function to display a relationship between the universal keys A to H and the functions associated therewith can be set. As the guide function, the display key 17g of the remote controller 17 is operated, as shown in FIG. 8, to display the relationship between the universal keys A to H and the functions in such a manner that the relationship is overlaid on a normal display screen.

Furthermore, as the guide function, the relationship between the universal keys A to H and the functions can be automatically displayed at a certain type of timing, for example, a power-on state of the television broadcast receiver 11, for a predetermined period of time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
a key selecting section configured to select a predetermined key from a plurality of keys corresponding to a specific function in a plurality of keys arranged on a remote controller;
a function selecting section configured to select a predetermined function from a plurality of functions held by the video display device;
a storage section configured to store a key code of the key selected by the key selecting section and information representing the function selected by the function selecting section in association with each other;
a receiving section configured to receive a key code transmitted from the remote controller; and
a control section configured to, when the key code received by the receiving section is a key corresponding to the specific function, determine a function corresponding to the key code on the basis of a stored content of the storage section to execute the function.

2. A video display device according to claim 1, wherein
the function selecting section is configured to display a menu screen to select a function to be associated with the key selected by the key selecting section.

3. A video display device according to claim 1, wherein
the control section comprises:
a determining section configured to determine whether a key code received by the receiving section is a key corresponding to the specific function;
a reading section configured to, when the determining section determines that the key code is a key code of the key corresponding to the specific function, read information representing a function corresponding to the key code from the storage section; and
an executing section configured to execute a function corresponding to the information read by the reading section.

4. A video display device according to claim 1, further comprising:
a guide section configured to display association between the plurality of keys corresponding to the specific function and functions associated with these keys, the association being stored in the storage section.

5. A video display method comprising:
a first block of selecting a predetermined key from a plurality of keys corresponding to a specific function in a plurality of keys arranged on a remote controller;
a second block of selecting a predetermined function from a plurality of functions held by the video display device;
a third block of storing a key code of the key selected in the first block and information representing the function selected in the second block in association with each other;
a fourth block of receiving a key code transmitted from the remote controller; and
a fifth block of, when the key code received in the fourth block is a key corresponding to the specific function, determining a function corresponding to the key code on the basis of a stored content stored in the third block to execute the function.

6. A video display method according to claim 5, wherein
the second block displays a menu screen to select a function to be associated with the key selected in the first block.

7. A video display method according to claim 5, wherein
the fifth block comprises:
a determining block of determining whether a key code received in the fourth block is a key corresponding to the specific function;
a reading block of, when it is determined in the determining block that the key code is a key code of the key corresponding to the specific function, reading information representing a function corresponding to the key code from the stored contents stored in the third block; and
an executing block of executing a function corresponding to the information read in the reading block.

8. A video display method according to claim 5, further comprising:
a guide block of displaying association between the plurality of keys corresponding to the specific function and functions associated with these keys, the association is stored in the third block.

9. A video display system which controls a video display device on the basis of a key operation of a remote controller, the system comprising:
a key selecting section configured to select a predetermined key from a plurality of keys corresponding to a specific function in a plurality of keys arranged on the remote controller;
a function selecting section configured to select a predetermined function from a plurality of functions held by the video display device;
a storage section configured to store a key code of the key selected by the key selecting section and information representing the function selected by the function selecting section in association with each other;
a receiving section configured to cause the video display device to receive a key code transmitted from the remote controller; and
a control section configured to, when the key code received by the receiving section is a key corresponding to the specific function, determine a function corresponding to the key code on the basis of a stored content of the storage section to cause the video display device to execute the function.

10. A video display system according to claim 9, wherein
the function selecting section is configured to display a menu screen to select a function to be associated with the key selected by the key selecting section.

11. A video display system according to claim 9, wherein
the control section comprises:
a determining section configured to determine whether a key code received by the receiving section is a key corresponding to the specific function;
a reading section configured to, when the determining section determines that the key code is a key code of the key corresponding to the specific function, read information representing a function corresponding to the key code from the storage section; and
an executing section configured to execute a function corresponding to the information read by the reading section.

12. A video display system according to claim 1, further comprising:
a guide section configured to display association between the plurality of keys corresponding to the specific function and functions associated with these keys, the association being stored in the storage section.
